(19) United States
(12) Patent Application Publication
(10) Pub. No.: US 2009/0180291 A1
(43) Pub. Date: Jul. 16, 2009

(54) Apparatus for replacing existing light emitting device and method for installation without modification to existing equipment.

(76) Inventor: Fai Koi Tam, North York (CA)

Correspondence Address: FAI KOI TAM, P.O. BOX 94507, 2900 STEELES AVENUE. EAST, THORNHILL, ON, L3T 7R5, CA

(21) Appl. No.: 12/015,153

(22) Filed: Jan. 16, 2008

(51) Int. Cl. B60Q 1/00

(52) U.S. Cl. 362/487

(57) ABSTRACT

Apparatus for replacing existing light emitting device and method for installation without modification to existing equipment, with a continuous pattern of Light Emitting Diode (LED) assembly forming a distinct light pattern, at least one LED(s) mounted on flexible PCB formed about the LED assembly, the LED assembly has open end that can pass through a mounting hole for installation, the LED assembly is flexible to bend for installation, the LED assembly will return to original shape after installation, installation of the LED assembly by feeding assembly through mounting hole in a rotating forward motion, and the LED assembly has of transmitting power from power source to LED(s).

### CROSS REFERENCE TO RELATED APPLICATIONS

This application claims benefit of provisional application Ser. No. 60/885,209 filed on Jan. 16, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of illumination devices and more specifically to illumination devices where a light bulb or other device is typically installed through an opening into a housing.

The preferred embodiment of the present invention is particularly useful for replacing incandescent lamps used in automobiles, boats, aircraft and other vehicles, where the invention would be applied as a replacement for incandescent bulbs and use light emitting diodes (LEDs) as the source of illumination. Current LED devices produce very directional light emission. The placement and location of these LEDs in a light module should be spread out to maximize the projected effective area of light emission when viewed in operation. The result of spreading out the LEDs produces a light pattern.

The prior art describing incandescent lamps generally describes a glass bulb mounted in a brass bayonet base, a plastic base, or an integrated glass base, all having either single or dual contacts. One type of these incandescent lamps is described in Devir et al., U.S. Pat. No. 4,603,278. Incandescent vehicle lamps have a perceived single point of light emission at the filament. The invention has multiple points of light emission that are distinct and create a light pattern. The preferred embodiment of the invention has provisions for several standard mounting bases having both single or dual contacts.

Lodhie et al., U.S. Pat. No. 6,598,996, Wesson, U.S. Pat. No. 6,371,636, and Cheselske, U.S. Pat. No. 5,160,200 describes an automotive replacement LED lamp with multiple points of light emission from discreet LEDs. The LEDs in these lamps are located in a concentrated small area and in turn cause them to be perceived as a single point of light emission when viewed in operation. The nature of LEDs produces very directional light emission therefore these lamps have a small projected effective area of light when viewed in operation. The function of multiple LEDs in close proximity to each other within a confined area could be limited or prevented by an inability to adequately dissipate the heat produced by the LEDs. The preferred embodiment of the invention has a circular arm that allows the light emitting devices to be spread out causing the projected effective area of light emission to be much larger and form a light pattern. The spread out light emitting devices also allows a much greater ability to dissipate heat.

Roney et al., U.S. Pat. No. 5,632,551 and Hochstein, U.S. Pat. No. 6,045,240 teaches one approach to producing a light pattern and providing a large projected effective area of light when viewed in operation. Roney and Hochstien describe an array of LEDs mounted on a large fixed substrate with the LEDs spread out in a pattern. Huang, U.S. Pat. No. 5,947,588 has a similar approach but also incorporates a housing with lens. These lamps are not designed to fit through a standard automotive light module mounting hole and do not fit in standard automotive lamp sockets. The preferred embodiment of the invention has a circular arm that has enough flex to allow for installation through a standard automotive mounting hole and mates to standard lamp sockets.

Examples of lighting fixtures on a single vehicle where the invention may be implemented can include headlights, taillights, turn signals, brake lights, fog lights and other fixtures that will be known to those of skill in the art. Vehicles with such devices include and are not limited to motorcycles, boats, cars, busses, trucks, aircraft and other motorized or non-motorized devices. Other implementations of the invention may include decorative or functional lighting devices such as household or industrial lighting and hand-held flashlights that are designed around or with a bulb-type light source, and the choice of light source for the device is effectively limited by the opening, housing and connector type as configured for the light bulb.

By providing a new type of light source, this invention can provide a variety of lighting patterns with the lighting configured in a manner that will allow adequate heat dissipation. The invention is designed in a manner that allows a portion of the device to deform or flex to allow for installation and creating a lighting pattern that is larger than the opening size for installation of a typical bulb. The expanded lighting area can allow multiple lighting patterns to be designed. The mounting portion of the lighting device can be designed for compatibility with existing or future connectors, mounting bases and electrical contact specifications.

### BRIEF SUMMARY OF THE INVENTION

The primary object of the invention is to provide a pattern of LEDs (i.e. a circular pattern).

Another object of the invention is to provide a robust lighting system with no moving parts.

Another object of the invention is to provide an apparatus and method to replace light emitting device.

A further object of the invention is to provide an apparatus and method to replace light emitting device without modifying existing access hole.

Yet another object of the invention is to provide an apparatus and method to replace light emitting device without modifying existing housing.

Still yet another object of the invention is to provide an apparatus and method to replace light emitting device without modifying existing socket.

Another object of the invention is to provide an apparatus and method to replace light emitting device without modifying power source.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed apparatus for replacing existing light emitting device and method for installation without modification to existing equipment. comprising: a continuous pattern of Light Emitting Diode (LED) assembly forming a distinct light pattern, at least one LED(s) mounted on flexible PCB formed about said LED assembly, said LED assembly has open end that can pass through a mounting hole for installation, said LED assembly is flexible to bend for installation, said LED assembly will return to original shape after installation, installation of said LED assembly by feeding assembly through mounting hole in a rotating forward motion, and said LED assembly has means of transmitting power from power source to LED(s).

In accordance with a preferred embodiment of the invention, there is disclosed a process for Apparatus for replacing existing light emitting device and method for installation without modification to existing equipment. comprising the steps of: a continuous pattern of Light Emitting Diode (LED) assembly forming a distinct light pattern, at least one LED(s) mounted on flexible PCB formed about said LED assembly, said LED assembly has open end that can pass through a mounting hole for installation, said LED assembly is flexible to bend for installation, said LED assembly will return to original shape after installation, installation of said LED assembly by feeding assembly through mounting hole in a rotating forward motion, and said LED assembly has means of transmitting power from power source to LED(s).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in a circular form.

FIG. 2 is an exploded view of the invention.

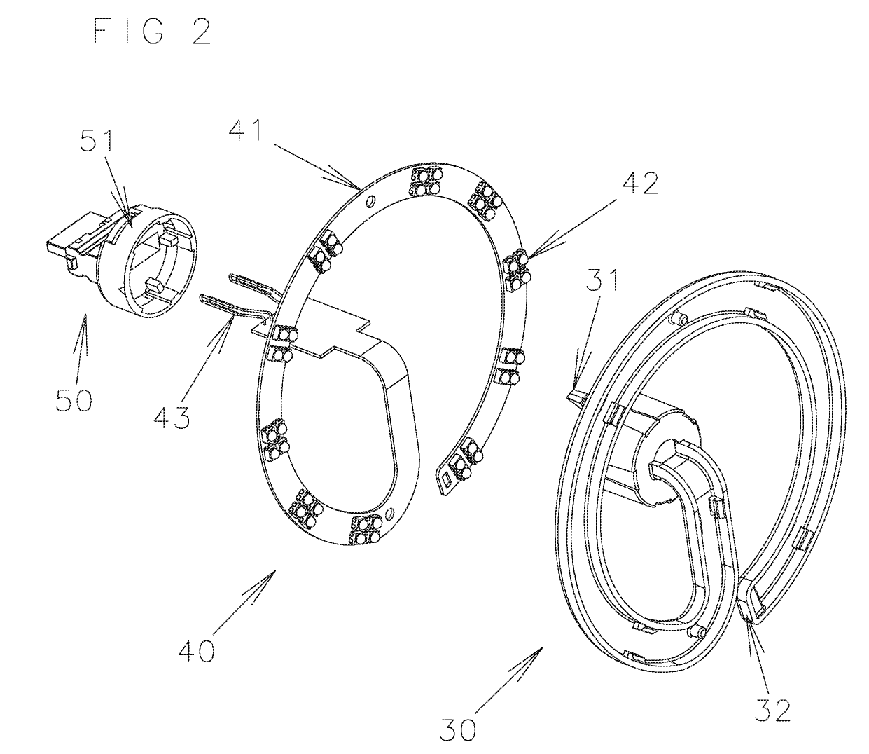

FIG. 3 is a perspective view of the invention showing how it would be assembled on to standard wire harness socket.

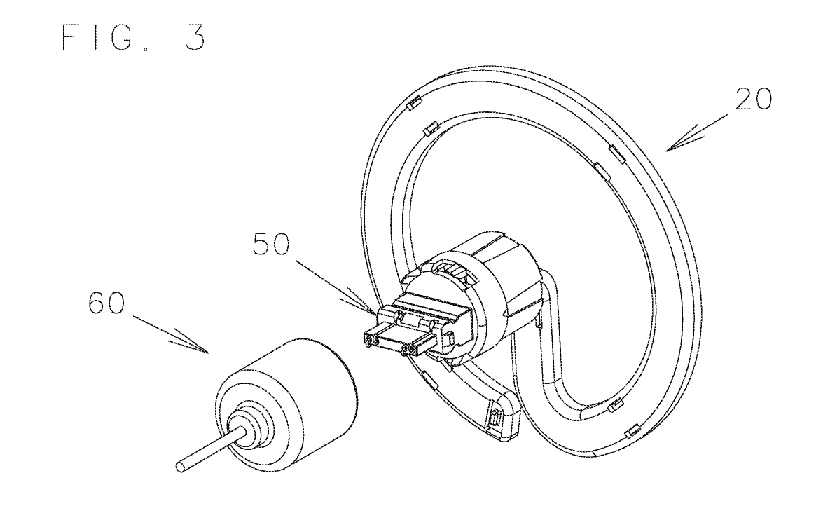

FIG. 4 is a perspective view of the invention installing into the taillight module of a vehicle.

FIG. 5 is a perspective view of the invention installed into the taillight module of a vehicle.

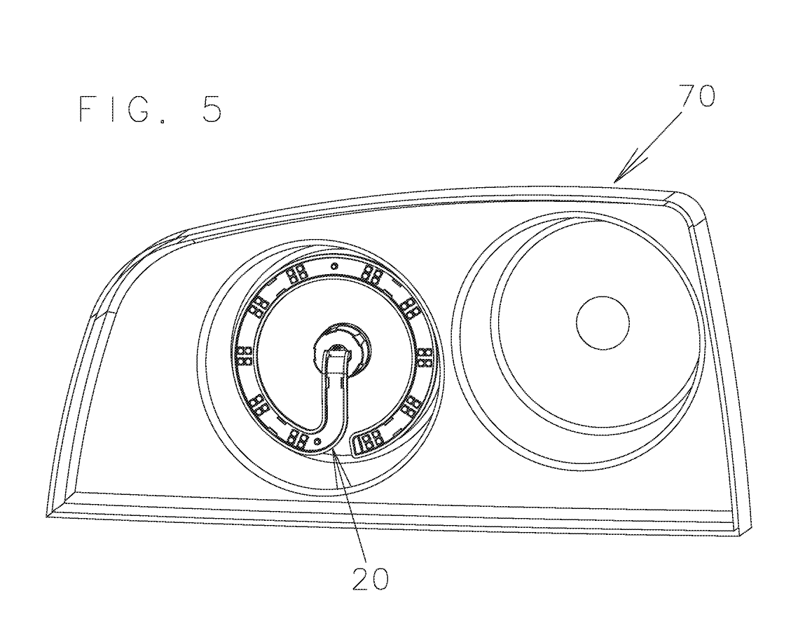

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The above described drawing figures illustrate the invention 20, an illumination device with arms that flex and bend entering a hole 20 for use in a housing designed for an incandescent light bulb such as the taillight module 70 or similar device. In the preferred embodiment, the invention 20 can function as a brake signal, turn signal, taillight, headlight or other applications.

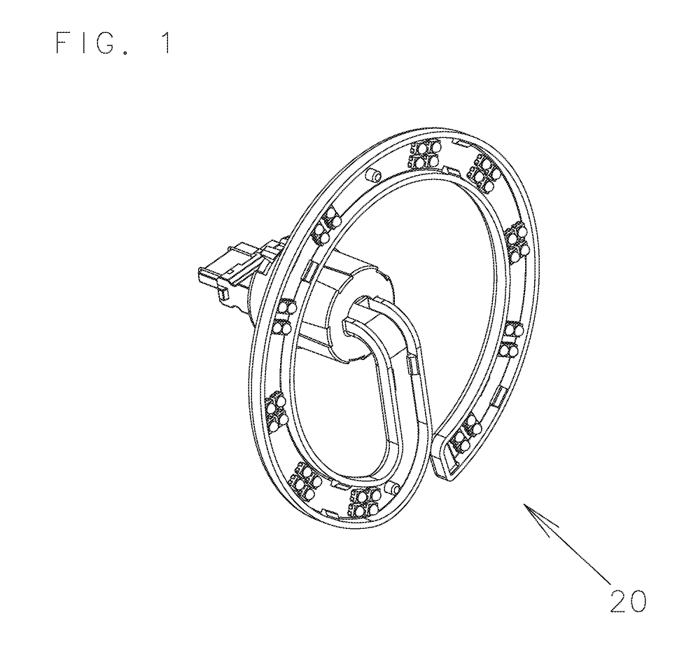

As shown in FIG. 1, an embodiment of the present invention includes a body 30 that provides a structure to house and secure a printed circuit board (PCB) 40. The body may also house or support additional light emitting devices.

The PCB 40 is used to distribute and optionally adapt electrical power from the mating socket 50 using the wires 43 and supply power through PCB 41 to individual light emitting device 42. The power adaptation may include, but is not limited to, regulating voltage, limiting current, and/or implementing a pulse width modulating generating device. The mating socket 50 is a standard shape which mates with a connector such as a standard automotive wire harness socket 60. The mating socket 50 is fastened into the body 30 using snaps 31 which are retained by walls 51. Other fastening, connection and installation mechanisms may be used and implemented on one or more embodiments of the invention to allow the invention to be used as a replacement or substitute for a variety of bulbs in a variety of applications.

The PCB 40 may be single or double sided and contains the light emitting devices 42 and can also contain other electrical components, such as resistors (not shown). In the preferred embodiment, the light emitting devices are light emitting diodes (LEDs).

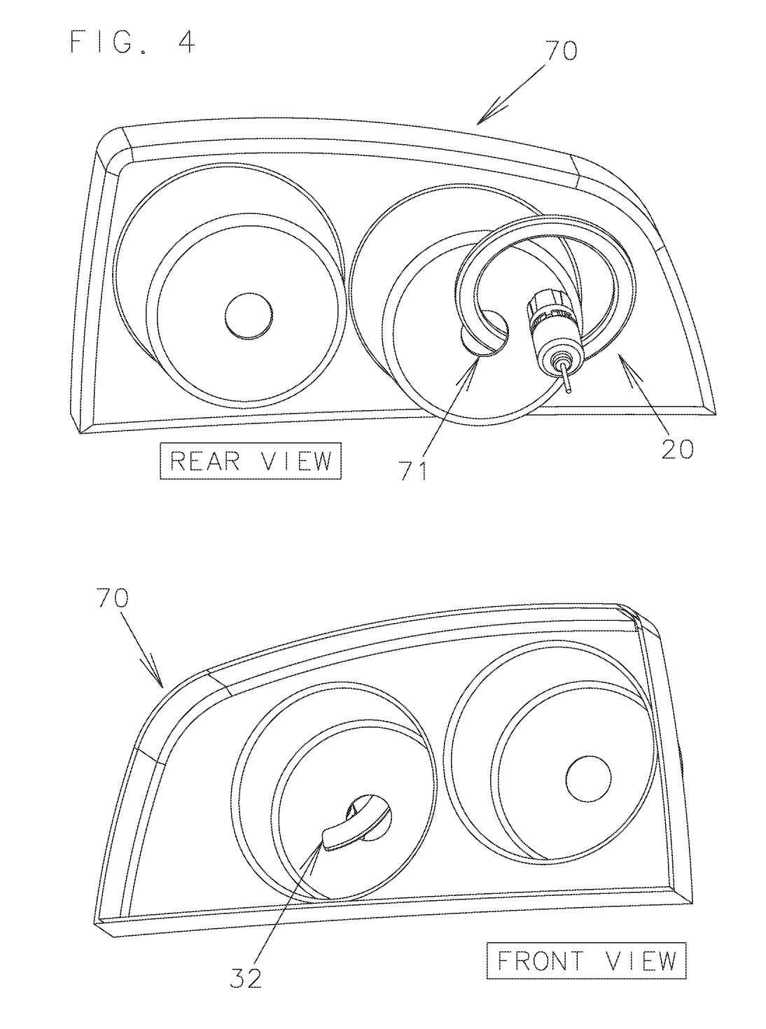

To accomplish an important function of the invention, there is shown in FIG. 4 the installation of the invention in a lighting module 70. The open end of the invention 32 is flexed outward and fit through the opening of the mounting hole 71. The invention 20 is then rotated until the entire body 30 with the light emitting devices 42 passes through the mounting hole 71.

The shape and size of the body 30 is specified to allow the assembly of the invention 20 into the lighting module 70 while rotating through the mounting hole 71. Embodiments of the invention may therefore have different radius (per the preferred embodiment) and height to accommodate a variety of lighting modules. Furthermore, the shape of the body may not be necessarily concentric to the mating socket 50 or symmetrical.

Other alternative embodiments may include the following elements; a non-standard mating socket which will fit a modified light bulb wire harness; a non-standard mating socket that accepts standard automotive electrical power through an adapter or other third-party device; hook up wires that transmit electrical power from the wire harness and distributes it directly to the light emitting devices; an alternative substrate, such as metal strips, with light emitting devices on one or both sides.

The distribution and control of the light emitting devices on the assembly may be done in a manner that allows individual activation of any given light source, and the intensity of light from each of the devices to be varied. In this manner, a given set of LEDs on the assembly can be actuated to display a variety of patterns with varying timing.

Additional means may be provided to allow an operator to select a display pattern, or set the timing of display patterns. In such an instance, the connector, power distribution and PCBs would be able to handle and use command and control signals from one or more input devices.

While the lighting devices will typically use electrical power, other types of lighting devices and power sources may be used within the invention. For example, optical fibers or light pipes may be used to deliver the illumination to the arms. Other power sources and lighting devices may occur to those of skill in the art.

While the embodiments described herein are primarily for replacement of bulbs for existing applications, new applications, fixtures and connectors may be specifically designed to use embodiments of the invention described herein.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Apparatus for replacing existing light emitting device and method for installation without modification to existing equipment comprising:
a circular arm with a means of supporting at least one light emitting device;
a means for said arm to elastically flex for installation through a mounting hole and return to its original shape after installation;
a socket for connecting the device to an electrical source providing control and power to the lighting device;
a means of transmitting power from the said socket to the said light emitting device;
a body with a means of supporting the said arm, and the said socket;

2. The invention of claim 1, wherein the installation of the device is done by feeding the assembly through a mounting hole in a rotating and transitional motion;

3. The invention of claim 1 wherein the device has discreet light emitting devices which are spread out and form a distinct light pattern.

4. The invention of claim 1, wherein at least one of said body and said arm contains components for adapting the power source to the required operating characteristics of the device

5. The invention of claim 4, wherein said component for adapting the power source allows the intensity, duration, frequency and timing of illumination of the said light-emitting devices to be varied to create random or pre-determined lighting patterns

6. A process for apparatus for replacing existing light emitting device and method for installation without modification to existing equipment comprising the steps of:
a continuous pattern of Light Emitting Diode (LED) assembly forming a distinct light pattern;
at least one LED(s) mounted on flexible PCB formed about said LED assembly;
said LED assembly has open end that can pass through a mounting hole for installation;
said LED assembly is flexible to bend for installation;
said LED assembly will return to original shape after installation;
installation of said LED assembly by feeding assembly through mounting hole in a rotating forward motion; and
said LED assembly has means of transmitting power from power source to LED(s).
